(19) United States
(12) Patent Application Publication
(10) Pub. No.: US 2002/0088899 A1
(43) Pub. Date: Jul. 11, 2002

(54) Flying object with a rotational effect

(76) Inventor: Srecko Ugrin, Beograd (YU)

Correspondence Address: John S. Egbert, Harrison & Egbert, 7th Floor, 412 Main Street, Houston, TX, 77002, US

(21) Appl. No.: 10/092,671

(22) Filed: Mar. 7, 2002

Related U.S. Application Data
(63) Continuation-in-part of application No. 09/601,268, filed on Jul. 29, 2000.
Application No. 09/601,268 is a 371 of international application No. PCT/YU98/00013, filed on Apr. 8, 1998.

(51) Int. Cl. B64C 29/00

(52) U.S. Cl. 244/23 R

(57) ABSTRACT

A flying object with a rotational effect includes a base, a plurality of wheels suitable for starting and landing the flying object, a first platform, a second platform, a cover, a first engine by which rotation of the first platform is provided, a second engine by which the second platform rotates, a third engine by which the cover rotates, a jet engine mechanism for starting, flying and landing the flying object, and an outlet of the jet engine mechanisms. There is also a communicator between the base and second platform and a connector for the first platform, second platform and cover when all rotations are in the same alignment.

### RELATED U.S. APPLICATIONS

The present invention is a continuation-in-part of co-pending application, U.S. Ser. No. 09/601,268, filed on Jul. 29, 2000, entitled “FLYING OBJECT WITH A ROTATIONAL EFFECT”.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention belongs to the field of flying and to flying objects driven by an engine and used for transport of people and loads and for other purposes. It relates to achievement of effects in tremendously increasing velocity, in minimizing spending of energy, in increasing capability for loading and in enlarging a moved distance without landing.

### BACKGROUND OF THE INVENTION

The invention solves four main problems which are present in functioning the flying objects driven by engine:

1) a significant reduction of energy spent in motion,

2) an enormous increase of speed,

3) considerable enlargement of rate of loading (a weight of embarked objects and part of a weight related to a crew and a passengers),

4) an increase of a distance moved with landing-no, which is achieved both on the basis of extension of a capacity for storing fuel, and on the basis of remarkable low quantities of spent energy.

The advantages of the invention presented above in four points constitute in the same time four main characteristics of efficiency of the invention.

The construction of the contemporary kinds of aircraft driven by engines is based on effects of a jet engine and on effects of rotating propellers.

The parts of the body of a contemporary aircraft remain in fixed position during a flying. The body of the aircraft connects all walls of the aircraft and volume closed by them which is suitable for placement of an engine, other technical devices, a load and accommodation of a crew and a passengers. The body does not include propellers and a stream of a jet engine. The body remains in fixed position during flying, i.e. no one part of the body changes position during the flight related to its other parts or related to things located within it while they are not in movement. This fixed position of the body represents an essential constitutive characteristic of the aircraft.

The rotation of three parts of a flying object creates lessening of the influence of gravity on rotating parts and the loads on the rotating parts. This effect improves the efficiency of flying. The rotation is not a means for lift. Centrifugal force can be directed to counter some gravitational attraction in flight. Increasing any effect of centrifugal force on gravity will lower the energy requirements to carry a cargo load and to fly.

According to the inventor, two vectors are present in relation between a centrifugal force and a gravitational attraction. The angle between them is 90 degrees during a phase of starting which precedes a phase of taking off. The intensity of centrifugal force increase with enlarging velocity of rotation. The relation between the two vectors disclose an advantage of the invention.

Furthermore, according to the inventor, the first and second platforms and cover rotate because the relationship improves the properties of the flying object. A crew of the flying object can move from a base to a second platform. This improvement contributes to the appearance of many advantages of the flying object which can be used during a flight, such as appearance of artificial gravitational attraction in the second platform in inter-planetary flight, possibly maintaining engines during a flight, and using cargo stocks during a flight.

The inventor proposes that the platforms and cover rotate in order that natural laws can be expressed in lessening the influence of gravitational attraction. These rotations provide particular effects in flying. The centrifugal force which is present in rotations ofthe platforms and in rotation of the cover constitutes one vector and gravitational attraction constitutes another vector. With the resultant vector created with them, an effect of lessening of gravitational attraction appears.

### BRIEF SUMMARY OF THE INVENTION

The body of the flying object with a rotational effect consists of a base and three pieces which rotate during a flight, about a particular axis of rotation. The three rotating pieces of the body rotate parallel to the base.

The inventor believes that the invention is based on natural laws which are incompletely defined in current science. A thorough discussion of the theoretical basis of the present invention can be found in the printed matter “Fundamentals of Physics are Out of Date and Wrong” (2001) by the present inventor.

The full efficiency in flying is reached when the base and three rotating pieces of the body are in position which makes a right angle with a direction of an influence ofthe attraction of gravity (of earth or other planets). This direction of rotational motion is designed here with the following terms: horizontal motion, horizontal rotation, horizontally, horizontal position, etc.

The flying object possesses two kinds of motion during flight, i.e. the motion of flying and the rotational motion.

The flying object flies horizontally or in another direction. Extraordinary special properties arise in the horizontal motion through effects in a field of velocity, capability in loading, in spending of energy and in capability of covering a greater distance without landing in comparison to effects which belong issued on the contemporary aircraft.

When the position of the flying object is not horizontal it spends a greater quantity of energy for the rotation of the three parts of the body than in case when it flies horizontally. In this occasion of the flying the effects of the significant reduction of spent fuel in motion is less than in case of the horizontal motion.

### BRIEF DESCRIPTION OF THE SEVERAL VIEWS OF THE DRAWINGS

FIG. 1 is a schematic view of the flying object of the present invention.

The parts of the flying object which are chosen to be presented in The Figure represent essential components of the flying object which are of importance for demonstrating the efficiency of the applied invention. These fractions of the figure relate to four pieces of the body, three engines for rotation, jet engine, three wheels needed for a starting motion of the flying object and for landing and to an outlet of a jet engine. The three wheels increase the mobility of the flying object when moving on land.

### DETAILED DESCRIPTION OF THE INVENTION

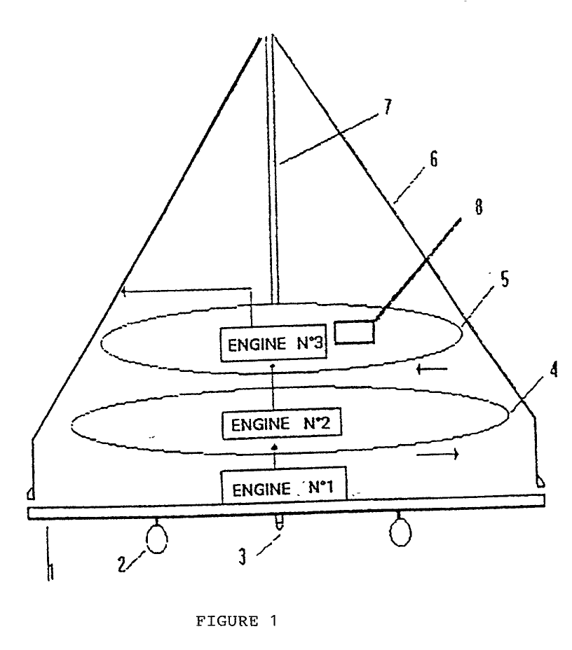

The body of the flying object consists of four pieces, as it is depicted in FIG. 1, i.e. of the base marked in the figure with 1, the first platform marked with 4, the second platform marked with 5 and the cover marked with 6.

The rotation of the first platform marked with 4 is produced with work of engine marked with the engine 1. The rotation of the second platform marked with 5 is effected with work of engine marked with the engine 2. The cover marked with 6 rotates with action of engine marked as the engine 3. The second platform (5) and the cover (6) rotate in the same direction. The first platform (4) rotates in opposite direction of rotation of the second platform (5) and the cover (6). The attributes of such engines are similar to characteristics of those engines which are customarily used for other rotational purposes. They are similar to characteristics of the engines for trucks, for other vehicles or for vessels, i.e. to attributes of other kinds of engines ofthe same category. These engines are designated in the further text as the engines for rotation.

A power and a force of the engines for rotation are transmitted over an axis to the rotational pieces of the body. The engines for rotation are fixedly connected to their respective platforms or cover so as to rotate around a vertical axis of the flying object. FIG. 1 shows the three separate engines aligned along the vertical axis. A central axis with toothed gears are located in opening in the centers of the platforms and cover.

The main construction material is metal. The shape of the base and of the platforms is circular. The cover is shaped in the form of a lateral surface of a cone or as halves of a sphere or spherical sector, etc. These three rotating parts of the body rotate regularly with the same speed. The engine 1 is fixed to the base (1), the engine 2 to the first platform (4) and the engine 3 to the second platform (5).

The rotation of the second platform (5) has a relative static position in comparison to any chosen point in the base (1) or to an exterior point out of the flying object when it is at state of rest, i.e. a distance between this exterior fixed point and the chosen point in the second platform (5) has constant magnitude and it does not change when the flying object is not in motion. Communication between the base and second platform is provided with a tube located in space around the vertical axle of the flying object, having a diameter of 1.5 m and a ladder fixed on a wall of the tube such that only bars of the ladder are visible. The communication provides many advantages which can be used during flight, such as artificial gravitational attraction in the second platform during flight, maintaining engines during flight and using loads and cargo during flight.

The second platform (5) provides conditions for loading and accommodation of people. The people, the load, the jet engine, the engine 3 and the fuel are placed in the second platform (5). The engine 2 is located on the first platform (4). Alternatively, the people may be accommodated on the base (1). The first platform, second platform and cover do not rotate in the same direction.

The achievements of the effects of the flying object, such as they are presented previously, depend on the level of the reached speed of the rotational parts of the body. The representing speed of the rotating pieces is the speed of the middle point placed in the middle of the distance between an axis and a rim of the platforms and of the cover, i.e. the speed ofthe middle point on a radius of the platforms and of the cover. When this speed is beneath 20 m/s the results will be moderate, when it is 30 m/s, they will be successful, when it is close to 50 m/s they will be excellent and when it is 100 m/s they will be more than extraordinary.

The rotation of rotational elements of the invention do not provide lifting. They contribute the great effectiveness in launching and flying of the flying object in a way that the rotation provides lessening of gravitational attraction on rotational parts of the flying object and on cargo located on the second platform of the flying object.

The flying object moves by effects produced with the jet engine marked with 8. The outlet of the jet engine is presented in The Figure with a number 3. Its location can be alternatively placed in other parts of the flying object. The jet engine does not rotate the platforms. The jet engine provides exclusively a flight power. The jet engine, fixed to the second platform, makes the flying object take off, fly and land and has connections to a plurality of wheels and to the outlet. The function of the jet engine is based on the same principle ofjet engines of the prior art. The jet engine is connected to the outlet by using space located along the vertical axle.

The wheels are marked in The FIGURE with number 2.

The cover (6) suspended on the vertical axis marked with 7 slides in the groove on the base (1). It is necessary to provide a separate protection from a difference of pressures, temperatures and quantity of oxygen inside and outside the flying object. In this respect it is convenient to set a cabin for weight and accommodation on the second platform (5) made from a transparent material and shaped as a lateral surface of a cone covering the whole platform. This cabin will provide this protection. The radius of the platforms, i.e. the radius of the cover is determined with the chosen dimensions of the flying object. The distance between the first platform (4) and a top point of the cover (6) is determined with criteria for stability of the flying object and in accordance with determined purpose of use of the flying object. In this respect the flying object for the use as a space ship can have a larger magnitude of the radius than when the flying object is to be used for other purposes.

The main efficiency of the subjected flying object originates from the rotational motion of three parts of the body. The invention relates to this effectiveness. With improvements and developments of functions of technical components and the operations between them the final effects of this flying object can reach utmost results but the difference in efficiency obtained in this way will be always significantly smaller in comparison of the difference which appears with the application the main attributes of the patent. Therefore, the improvements of this kind could not be constituted with such inventions by which is possible to annul validity of this invention. They will have a meaning of improvement of this invention. In this respect they can relate to all solutions regarding to functioning of the parts of the flying object and to other alternative solutions but not to main characteristics of the flying object. For example they can refer to solutions like: the engine 1 is placed on the first platform (4), the cover (6) consists of more than one piece, only one engine rotates three rotating pieces ofthe body, the rotations of three parts of the body is produced with connections between rims and not over an axis, the metal is replaced with an another material, etc. The improvements ofthe patent should be introduced with acquired experiences in its application. For example, if engine 1 is located on the first platform (4) instead on the base (1) the effects of flying will be greater. However, a more precise experiences in a field of stability and vibration of object are necessary for application of such solution.

I claim:

1. A flying object with a rotational effect comprising
a base,
a plurality of wheels positioned on said base and suitable for starting and landing the flying object,
a first platform rotatable parallel to said base,
a second platform rotatable parallel to said base,
a cover rotatable about an imagined line positioned along a length of a vertical axis,
a first engine fixed to said base by which rotation of said first platform is provided,
a second engine fixed on said first platform by which said second platform rotates,
a third engine fixed to said second platform by which said cover rotates,
a jet engine means fixed on said second platform for starting and taking off, flying and landing the flying object, and
an outlet of said jet engine means,
wherein rotations of said first platform, said second platform and said cover have a same magnitude of speed and with two directions such that said first platform rotates in an opposite direction than a direction of rotation of said second platform and said cover, and
further comprising means for communication between said base and said second platform and means for connecting said first platform, said second platform and cover when all rotations are in the same alignment, said first platform, said second platform and said cover being rotatable by using only one engine fixed on said second platform.
